(19) United States
(12) Patent Application Publication
(10) Pub. No.: US 2018/0305980 A1
(43) Pub. Date: Oct. 25, 2018

(54) Spring-Tensioned Roll-Up Wall

(71) Applicants: David R. Hall, Provo, UT (US); Joe Fox, Spanish Fork, UT (US); Andrew Priddis, Mapleton, UT (US); Jackson Priddis, orem, UT (US)

(72) Inventors: David R. Hall, Provo, UT (US); Joe Fox, Spanish Fork, UT (US); Andrew Priddis, Mapleton, UT (US); Jackson Priddis, orem, UT (US)

(21) Appl. No.: 15/495,118

(22) Filed: Apr. 24, 2017

(51) Int. Cl. E06B 9/72; E06B 9/80; E06B 9/60; E06B 9/08; E04B 2/74

(52) U.S. Cl. CPC E06B 9/72; E06B 9/80; E04B 2/74; E06B 9/08; E06B 9/60

(57) ABSTRACT

Potential for remote interaction with various architectural features has increased dramatically with recent technological developments. For example, modular spaces may allow an occupant to quickly and effortlessly modify an existing space to the occupant's needs. One of the challenges of remotely operating devices is energy efficiency. An apparatus is described herein that addresses this issue. The apparatus may include a flexible panel, a roller tube, one or more mounting brackets, a braking mechanism, and a torsion spring. The torsion spring may be pre-torsioned with a number of rotations. The number of rotations may be determined by various formulas, and/or the apparatus may have a trough-shaped torque profile. This may minimize external energy requirements of the apparatus, such as by a motor.

### TECHNICAL FIELD

This invention relates generally to the field of building structures and more specifically to architectural coverings.

### BACKGROUND

As the interconnectivity of devices, especially home and office devices, grows, the potential for modular spaces has increased dramatically. Modular spaces may allow an occupant to quickly and effortlessly modify an existing space to the occupant's needs. Thus, a bedroom may be converted to an office, a kitchen may be converted to a gathering room or a bedroom, a gathering or living room may be converted to several bedrooms, et cetera. One of the challenges of modifying spaces is changing and/or subdividing the dimensions of the space while still maintaining the privacy of the space. Some solutions to this problem have included modular walls. However, to date, modular walls are either heavy and require a significant amount of energy to move around and/or store, or lack the privacy most uses require.

Another problem exists with regard to the raising and lowering of the roll-up mechanisms, such as shades, walls, and doors, and associated elements such as lift cords and bottom bars, as are known in the art. Prior art solutions include motor driven systems connected to outside power sources. These systems are powerful enough to simply muscle a cover up and down no matter what the weight of the system and despite the high torque requirements to be overcome. These systems are usually bulky, noisy and expensive. Further, despite the advantages the un-counterbalanced weight of the shade system eventually will wear out these systems and lead to expensive replacement options.

For each particular roll-up system, a certain amount of torque must be applied to raise and lower an element. Thus, each system has a particular “torque profile”. With powered systems, the prior art solution, again, is simply to apply more than enough power to overcome the torque requirements. Counterbalanced systems are known in the art that attempt to offset at least partially the heavy weight and torque requirements of a roll-up system so that quieter, less expensive battery powered systems are possible. Most of these systems known to the Applicants involve complicated arrangements of springs, gears and transmission systems. In sum, each of the prior art systems attempts to overcome by brute electrical mechanical force the torque profile created by the weight of the hanging element and connected elements of a particular system or to partially compensate for, to counterbalance, the weight by means of complicated spring, gear and transmission systems. Further, prior art spring counterbalance systems generally overcompensate to ensure complete retrieval of an extended element. Importantly, none of the prior art systems known to Applicants enables a user to construct a counterbalance system that approximates the torque profile of any particular shade system without undue overcompensation and that is easy to add to and delete from as circumstances dictate. Thus, there is significant room for improvement to roll-up systems.

### SUMMARY OF THE INVENTION

Embodiments of a spring-tensioned roll-up wall are described herein that address at least some of the problems described above in the Background. One way the disclosed system addresses such problems is by significantly increasing the precision with which the spring is tensioned in the roll-up wall. Another way the system improves on previous systems is by creating a trough-shaped torque profile for the system centered roughly around zero net torque for a fixed torque applied by a motor.

Various embodiments may include a flexible panel, a roller tube, a drawbar, one or more mounting brackets, a braking mechanism, and a torsion spring. The flexible panel may have a thickness ranging from 0.005 inches to one inch, a panel length ranging from 24 inches to 600 inches, a bottom end, and a top end. The roller tube may be connected to the top end of the flexible panel. The tube may have an outer diameter ranging from half an inch to 25 inches. The panel may roll onto, and off of, the tube. The drawbar may be connected to the bottom end of the panel. The drawbar may have a weight ranging from half a pound to 80 pounds. At least one mounting bracket may be rotatably connected to the tube. The braking mechanism may be connected to the tube and at least one of the one or more mounting brackets. The braking mechanism may prevent rotation of the tube relative to the one or more mounting brackets. The torsion spring may be disposed within the tube and connected directly, indirectly, or both, to the tube and at least one of the mounting brackets. The spring may be pre-torsioned with a number of rotations as the panel is fully rolled onto the tube. The number of rotations may be determined by: one-half the drawbar weight, multiplied by the square root of the sum of: the product of four, the thickness of the panel, and the length of the panel, divided by pi; and the square of the outer diameter of the tube.

Various embodiments may include a flexible panel, a roller tube, one or more mounting brackets, a braking mechanism, and a torsion spring. The flexible panel may include a bottom end and a top end. The roller tube may be connected to the top end, and the panel may roll onto, and off of, the tube. At least one of the mounting brackets may be rotatably connected to the tube. The braking mechanism may be connected to the tube and at least one of the one or more mounting brackets. The braking mechanism may prevent rotation of the tube relative to the mounting brackets. The torsion spring may be disposed within the tube. The torsion spring may include a first end connected directly, indirectly, or both, to the tube. The torsion spring may include a second end connected directly, indirectly, or both, to at least one of the mounting brackets. The spring may be pre-torsioned before the mounting brackets are mounted to a mounting surface. The pre-torsioning may be accomplished by rotating the second end of the spring relative to the first end of the spring in the same direction as the tube rotates to roll the panel off the tube. Such pre-torsioning may give the apparatus a trough-shaped torque profile.

### BRIEF DESCRIPTION OF THE DRAWINGS

A more particular description of the system summarized above is made below by reference to specific embodiments. Several embodiments are depicted in drawings included with this application, in which:

FIG. 1 depicts a modular office space;

FIG. 2 depicts a roll-up wall assembly;

FIG. 3 depicts a roll-up wall assembly with the flexible panel removed;

FIG. 4 depicts a cross-section of a roller tube;

FIG. 5 depicts various internal components of a roll-up wall assembly;

FIG. 6 depicts an additional embodiment of various internal components of a roll-up wall assembly;

FIG. 7 depicts a zoomed-in view of internal components of a roll-up wall assembly;

FIG. 8 depicts a zoomed-in view of various other internal components of a roll-up wall assembly;

FIG. 9 depicts a motor transmission;

FIG. 10 depicts a slip ring;

FIG. 11 depicts a bottom-weighted support ring; and

FIGS. 12A-B depict various torque profiles.

### DETAILED DESCRIPTION

A detailed description of embodiments of a spring-tensioned roll-up wall is provided below by example and with reference to embodiments in the appended figures. Those of skill in the art will recognize that the features of the apparatus as described by example in the figures below could be arranged and designed in a wide variety of different configurations. Thus, the detailed description and the description of the embodiments in the figures is merely representative of embodiments of the invention, and is not intended to limit the scope of the invention as claimed.

Various embodiments of a spring-tensioned roll-up wall may include a flexible panel, a roller tube, a drawbar, one or more mounting brackets, a braking mechanism, and a torsion spring. The flexible panel may have a thickness ranging from 0.005 inches to one inch, a panel length ranging from 24 inches to 600 inches, a bottom end, and a top end. The roller tube may be connected to the top end of the flexible panel. The tube may have an outer diameter ranging from half an inch to 25 inches. The panel may roll onto, and off of, the tube. The drawbar may be connected to the bottom end of the panel. The drawbar may have a weight ranging from half a pound to 80 pounds. At least one mounting bracket may be rotatably connected to the tube. The braking mechanism may be connected to the tube and at least one of the one or more mounting brackets. The braking mechanism may prevent rotation of the tube relative to the one or more mounting brackets. The torsion spring may be disposed within the tube and connected directly, indirectly, or both, to the tube and at least one of the mounting brackets. The spring may be pre-torsioned with a number of rotations as the panel is fully rolled onto the tube. The number of rotations may be determined by: one-half the drawbar weight, multiplied by the square root of the sum of: the product of four, the thickness of the panel, and the length of the panel, divided by pi; and the square of the outer diameter of the tube.

Various embodiments may include a flexible panel, a roller tube, one or more mounting brackets, a braking mechanism, and a torsion spring. The flexible panel may include a bottom end and a top end. The roller tube may be connected to the top end, and the panel may roll onto, and off of, the tube. At least one of the mounting brackets may be rotatably connected to the tube. The braking mechanism may be connected to the tube and at least one of the one or more mounting brackets. The braking mechanism may prevent rotation of the tube relative to the mounting brackets. The torsion spring may be disposed within the tube. The torsion spring may include a first end connected directly, indirectly, or both, to the tube. The torsion spring may include a second end connected directly, indirectly, or both, to at least one of the mounting brackets. The spring may be pre-torsioned before the mounting brackets are mounted to a mounting surface. The pre-torsioning may be accomplished by rotating the second end of the spring relative to the first end of the spring in the same direction as the tube rotates to roll the panel off the tube. Such pre-torsioning may give the apparatus a trough-shaped torque profile.

Although principally described herein as a wall for dividing modular spaces, the system may more generally be understood as a roll-up architectural feature. The feature may form a wall, a door, and/or a shade. The door may, for example, be a garage door. The shade may be a window shade. Those of skill in the art recognize the structure claimed herein may be utilized in a variety of other ways.

The roll-up wall may be used in a modular space to adjust the dimensions of the space and/or to subdivide the space. The roller wall may be fixedly and/or moveably attached to one or more fixed walls and/or rails within a ceiling. The winding portion, such as the tube, of the roller wall may be disposed behind and/or within a ceiling, and the ceiling may include an opening corresponding to the flexible panel and/or the drawbar. In various embodiments, the roll-up wall may be mounted to any of a variety of surfaces by the mounting brackets. The mounting brackets may comprise a segment extending into the tube and a segment that mounts to the mounting surface. The tube may be rotatably connected to the segment extending into the tube, such as by one or more support rings having one or more bearings disposed between a portion of the ring fixed to the tube and a portion of the ring fixed to the mounting bracket.

The flexible panel may serve any of a variety of purposes, such as providing a visual barrier and/or an acoustic barrier. The material out of which the flexible panel is comprised may be suited for such purposes. For example, in one embodiment, the flexible panel is comprised of mass-loaded vinyl. As described above, the flexible panel may have a variety of thicknesses, which thicknesses may correspond to the desired features of the barrier. The panel thickness may range from 0.005 inches to one inch, from 0.01 inches to half an inch, or from 0.05 inches to 0.25 inches. In an optimal embodiment, the thickness is 0.12 inches. The present inventors have determined that, especially for embodiments including mass-loaded vinyl, the optimal thickness is 0.12 inches. The optimal thickness represents a balance between privacy and energy efficiency. As the thickness increases, the privacy due to sound and light attenuation increases. However, as the thickness increases, the weight also increases, decreasing the energy efficiency. At a certain thickness, the increase in privacy for additional thickness tapers while the energy efficiency decrease continues steadily. For a variety of materials, including mass-loaded vinyl, this thickness is 0.12 inches.

The flexible panel may have a variety of lengths, the length of the panel extending from the top end to the bottom end. The length may range from 24 inches to 600 inches, encompassing a variety of uses such as from covering a window or bar window to extending the entire height of a commercial warehouse/manufacturing facility. Depending on the application, the length may vary from 36 inches to 360 inches, from 48 inches to 240 inches, or from 72 inches to 180 inches. In an optimal embodiment, the panel length is 114 inches. The such an optimal embodiment may include a modular space with 8-foot (96-inch) ceilings. The additional 18 inches allows for the roll-up wall to be housed in the ceiling and to retain a portion of the flexible panel around the tube as the panel fully extends from the ceiling to the floor. This also minimizes the amount of material required.

The tube may be comprised of any of a variety of materials, including aluminum, steel, iron, carbon, carbon fiber, fiberglass, PVC, ABS, and nylon, among others. The tube diameter may be, in various embodiments, dependent on the panel thickness and length. Thus, an optimal tube diameter may correspond to one or more of the optimal panel thickness and the optimal panel length. Accordingly, the tube diameter may range from half an inch to 25 inches, from one inch to 10 inches, from two inches to eight inches, or from three inches to five inches. In an optimal embodiment, the tube diameter is four inches. Similarly, an optimal drawbar weight may correspond with the tube diameter. The drawbar weight may range from half a pound to 80 pounds, from one to 40 pounds, from two to 30 pounds, from five to 25 pounds, or from 10 to 20 pounds. In an optimal embodiment, the drawbar weight is 15 pounds. The drawbar may have a length perpendicular to a length of the flexible panel, and may be connected to the flexible panel bottom end along the drawbar length.

The tube may include a number of inward-protruding teeth that may engage with one or more torque transmissions disposed within the tube. In various embodiments, the teeth may span the entire length of the tube. This may allow for simplified construction by utilizing the same design for the various transmissions and support rings within the tube. This may also allow for more flexible positioning of such elements within the tube, and for on-site, post-assembly shortening of the tube to adapt to various needed sizes. The transmissions may correspond to the spring or one or more motors. The teeth may also engage with one or more internal support rings that allow the tube to rotate about fixed components disposed within the tube, such as components fixed to at least one of the mounting brackets. The number of teeth may range from one tooth to 64 teeth, from one to 32 teeth, from one to 16 teeth, for from one to eight teeth. In an optimal embodiment, the tube includes four teeth. The number of teeth may be optimal in balancing a minimum number of teeth to support the amount of torque exerted on the tube by the spring with using a minimal amount of material and reducing the complexity of constructing the tube. Additionally, the teeth may be evenly spaced within the tube, may have a uniform size, may be unevenly spaced, and/or may have a non-uniform size. For example, the tube may include a groove formed in an exterior surface of the tube. The groove may have a depth such that a tooth is formed protruding into the tube and outlining the groove. The top end of the flexible panel may insert into the groove and directly connect the flexible panel to the tube.

The tube may have a length perpendicular to the flexible panel length. The tube length may range from 32 inches to 320 inches, from 48 inches to 240 inches, from 60 inches to 150 inches, or from 84 inches to 124 inches. In an optimal embodiment related to the other optimal embodiments described above, the tube length is 100.5 inches. The spring may have an un-extended length parallel to the tube length. The un-extended spring length may be less than the tube length. For example, the un-extend spring length may range from 10 inches to 140 inches, from 18 inches to 96 inches, from 24 inches to 60 inches, or from 36 inches to 48 inches. In an optimal embodiment, the un-extended spring length is 25 inches. The spring may have a wire diameter ranging from 0.1 inches to 0.5 inches, from 0.15 inches to 0.4 inches, or from 0.2 inches to 0.3 inches. In an optimal embodiment, the spring has a wire diameter of 0.207 inches. The spring may have an inner diameter ranging from half an inch to five inches, from one inch to four inches, or from two inches to three inches. In an optimal embodiment, the spring inner diameter is 1.75 inches.

The torsion spring may be comprised of any of a variety of materials, such as iron and/or steel. The torsion spring may have a spring constant ranging from 2 in-lb/rad to 5 in-lb/rad. In an optimal embodiment related to the other optimal embodiments described herein, the spring constant is 3.789 in-lb/rad. The torsion spring may be extended from the spring's free-standing equilibrium length as it is disposed within the tube. Because the spring is fixed to the tube and the mounting bracket, as the tube rotates, such as to unroll the flexible panel, the space between adjacent coils of the spring decreases. Accordingly, the spring may be stretched/extended to account for the decreased inter-coil spacing. The pre-stretching of the spring may correspond to the length of the panel. Accordingly, the pre-stretch may range from one inch to 10 inches, from two inches to eight inches, or from four inches to six inches. In an optimal embodiment, the pre-stretch is four inches.

A bar may be disposed within the spring and connected at one end to at least one of the one or more mounting brackets and at the other end to the tube. The spring may be directly connected to the bar. The bar may retain the spring in the extended/stretched state within the tube. The bar may be directly connected at a first end to a spring-tension transmission. The spring-tension transmission may be directly fixed to the tube. For example, the spring-tension transmission may include one or more grooves corresponding to at least one of the inward-protruding teeth of the tube. The spring-tension transmission may have a diameter equal to an inner diameter of the tube. The bar may be rotatably connected to a second spring-tension transmission. The second spring-tension transmission may be directly fixed to the tube, and may be disposed around an element of the mounting bracket extending into the tube and directly connected to the bar. The second spring-tension transmission may have an outer diameter equal to the inner diameter of the tube and an inner diameter equal to an outer diameter of the mounting bracket element. The second spring-tension transmission may include one or more grooves corresponding to at least one of the inward-protruding teeth of the tube.

One or more of the bar, the spring-tension transmissions, and the mounting bracket element may include a groove around the circumference of the component. The groove may accommodate one or more fixing elements, such as set screws, that fix the spring in the extended/stretched state. The fixing elements may also secure the spring in the pre-torsioned state, and may secure the spring as a torsional force is exerted on the spring by the rotating tube.

The spring may be pre-torsioned by torsioning the spring and fixing the spring in the torsioned state within the tube. The number of rotations required to pre-tension the spring may depend on the torque (T_{wall}) exerted on the tube by the wall and connected elements in any particular state of the wall at which the spring may be pre-torsioned (such as fully rolled, or “open,” or fully unrolled, or “closed”) and the torsional spring constant (k) of the spring. The torque may depend on the drawbar weight (z), the thickness of the panel (t), the length of the panel (l), and the outer diameter of the tube (d). The torque may additionally depend on the width (w) and density (ρ) of the panel, and the relative rotational position (θ) of the tube from its initial “closed” position of zero. In embodiments where the spring is pre-torsioned in the open state, the number of rotations (Nᵣₒₜ) may be expressed as

$${N}_{rot} = \frac{T}{2 π k} , where$$

$${T}_{wall} = \frac{z}{2} {( \frac{4 tl}{π} + {d}^{2} )}^{\frac{1}{2}} .$$

These functions may determine the optimal amount of pre-tensioning for a given spring. Using the variables described above, a precise number of rotations may be selected for any torsion spring and for any wall at any position. This eliminates the guesswork and imprecision described above in the Background.

The roll-up wall may include a motor and transmission assembly. The motor and transmission assembly may rotate the tube and roll the panel onto, and off of, the tube. The motor and transmission assembly may be disposed within the tube. The motor and transmission assembly may include a variety of components, including a state, a transmission, and/or a rotor. The stator may be fixed, directly or indirectly, to at least one of the one more mounting brackets. The transmission may be directly fixed to the tube. In various embodiments, the transmission may have a structure similar to the spring-tension transmissions described above. Accordingly, the transmission may include one or more grooves corresponding to one or more of the inward-protruding teeth of the tube. The transmission may have an outer diameter equal to an inner diameter of the tube. The rotor may rotatably connect the stator and the transmission. A housing may be disposed within the tube that at least partially encloses one or more of the stator and the rotor. The housing may be comprised of aluminum, steel, iron, carbon, carbon fiber, fiberglass, PVC, ABS, nylon, and/or other similar materials. The housing may be directly fixed to the mounting bracket, and the stator may be directly fixed to the housing. Alternatively, the housing and the stator may both be directly fixed to the mounting bracket. The rotor may be rotatably connected directly to the housing, such as by a slip ring disposed between the rotor and the housing. The rotor may be connected to the housing at an end of the housing opposed the mounting bracket.

The amount of torque required by a motor (Tₘₒₜₒᵣ) incorporated into the system may depend on T_{wall} and the torque exerted by the spring (T_{spring}). T_{spring} may depend on k, the maximum rotational position (θₘₐₓ) of the system from zero, θ, and Nᵣₒₜ. Tₘₒₜₒᵣ may be inversely proportional to the sum of T_{spring} and T_{wall}, such that

$${T}_{motor} ∝ c ( {T}_{wall} + {T}_{spring} ) , where$$

$${T}_{spring} = k ( \begin{matrix}{θ}_{ma x} & θ + 2 π {N}_{rot}\end{matrix} ) , \\ {T}_{wall} = \frac{1}{2} [ ( tw ρ ( \begin{matrix}L & \frac{d θ}{2} & \frac{t {θ}^{2}}{4 π}\end{matrix} ) ) + z ] ( d + \frac{t θ}{π} ) ,$$

and where c is a negative constant.

The spring may be pre-torsioned before mounting the system to a surface or surfaces by rotating the mounting bracket connected to the spring the desired number of rotations and the fixing the mounting brackets to the surface or surfaces. The mounting bracket may be rotated in the same direction as the tube rotates to unroll the panel. Accordingly, as the panel is unrolled from the tube to θ, the tension in the spring may be reduced. At Nᵣₒₜ=2πθ, T_{spring} may equal zero. This may correspond with a fraction of L of the panel being unrolled from the tube. In general, as the panel is unrolled from the tube, the amount of mass unrolled per rotation decreases exponentially. Accordingly, the increase of T_{wall} slows. However, T_{spring} continues a linear increase in the opposite direction of T_{wall}.

In a pre-torsioned system as described in the previous paragraph, the amount of current required by the motor may vary to maintain equilibrium between Tₘₒₜₒᵣ, T_{spring}, and T_{wall}. Given a fixed Tₘₒₜₒᵣ, the roll-up apparatus may have a trough-shaped torque profile, or net torque (Tₙₑₜ). The spring may traverse its free-standing equilibrium torsional state as the panel is unrolled. Such may occur from one percent to 30 percent of the panel's length, from 10 percent to 40 percent of the panel's length, or from 25 percent to 50 percent of the panel's length. Additionally, the spring may be pre-torsioned as the panel is rolled fully onto the tube to more accurately ensure the trough-shaped torque profile. As implemented, the apparatus may have a a variable Tₘₒₜₒᵣ to flatten the apparatus torque profile such that the torque profile is roughly constant as the panel is unrolled and rolled. The Tₘₒₜₒᵣ profile relative to time may include various discontinuities, such as described in the following paragraph.

T_{wall} and T_{spring} may be balanced such that a minimal amount of Tₘₒₜₒᵣ is required, thus allowing for a small motor. Such is particularly beneficial in embodiments with large, heavy panels that may typically require a large, powerful motor. Using the formulas above, however, a minimal Tₘₒₜₒᵣ may be calculated. The motor may include a controller and a torque sensor connected to the motor's output or rotor and electrically connected to the controller. The controller may include instructions for receiving a torque measurement (e.g. T_{spring} and/or T_{wall}) from the torque sensor and adjusting Tₘₒₜₒᵣ proportionally. For example, as the torque measurement decreases, Tₘₒₜₒᵣ may be decreased, and as the torque measurement increases, Tₘₒₜₒᵣ may be increased. The controller may store a desired Tₙₑₜ, such as Tₙₑₜ=0. Tₘₒₜₒᵣ may have a lower threshold such that, as T_{spring}=−T_{wall}, Tₘₒₜₒᵣ is equal to the lower threshold. Tₙₑₜ may be equal to zero except at a range around T_{spring}=−T_{wall}, the range equal to a value ranging from the lower threshold to two times the lower threshold. The controller may include instructions for detecting and preventing the motor from over tensioning the spring.

Various embodiments may include torque sensors between the spring and the tube, between the spring and the mounting bracket, between the motor and the tube, or between the tube and the mounting brackets. The torque sensors may be electrically connected to a controller (such as the motor controller described in the previous paragraph), and the controller may store instructions that, when executed, compare the torques and throttle a current delivered to the motor based on a desired Tₙₑₜ.l The sensors may detect an over tensioned condition in the spring and report that condition to the controller. The controller may include instructions for detecting and preventing the motor from over tensioning the spring.

A support ring may rotatably connect the housing and the tube. The support ring may be rotatably connected directly to the housing and directly fixed to the tube. The support ring may include one or more grooves corresponding to one or more of the inward-protruding teeth of the tube. The support ring may have an outer diameter equal to an inner diameter of the tube and an inner diameter equal to an outer diameter of the housing. One or more bearings may be disposed between the support ring and the motor housing.

The motor and transmission assembly may exert a torque on the tube that is less than a torque required to roll up the panel. The torsion spring may reduce the torque required by the motor, allowing for a smaller, more energy-efficient motor to be used. Because of the weight of the wall, a larger motor might otherwise have to be used that would not fit within the tube. However, the torsion spring allows a smaller motor to be used that fits within the tube. In various embodiments, the motor and transmission assembly may exert a torque on the tube ranging from 5 in-lb to 320 in-lb, from 10 in-lb to 240 in-lb, from 20 in-lb to 100 in-lb, or from 30 in-lb to 60 in-lb. In an optimal embodiment related to other optimal embodiments described herein, the torque is 45 in-lb.

The braking mechanism may be implemented in the motor and/or between the motor and the tube. In some embodiments, the braking mechanism may comprise friction in the motor. In some embodiments, the braking mechanism may comprise a pawl and gear. An electric motor may disengage the pawl from the gear to allow the tube to freely rotate. In some embodiments, the brake comprises a cam and pins that prevent rotation of the cam. The cam may be connected to the rotor and the transmission, and the pins may be disposed between the cam and the motor housing.

A battery may be disposed within the tube. The battery may be electrically coupled to the motor, and may provide power to the motor. In various embodiments, the battery may be disposed within the tube between the motor and the spring. This may allow the motor and the spring to be fixed to opposing mounting brackets so that the spring may reduce the amount of torque required by the motor. The battery may be rotatably connected to the tube such that the tube rotates freely around the battery as the battery remains, relatively, stationary. Due to friction, some oscillation of the battery may be expected, such as a swing of up to 45 degrees. The battery may be rotatably connected to the tube by a support bearing. For example, the battery may be disposed in a bottom-weighted support slip ring that is fixed to the tube and rotatably connected to the battery. The slip ring may have a structure similar to other support rings and transmissions described herein.

Specific embodiments of the roll-up wall and roll-up wall components described generally above are depicted in the appended FIGs. and described below regarding those FIGs.

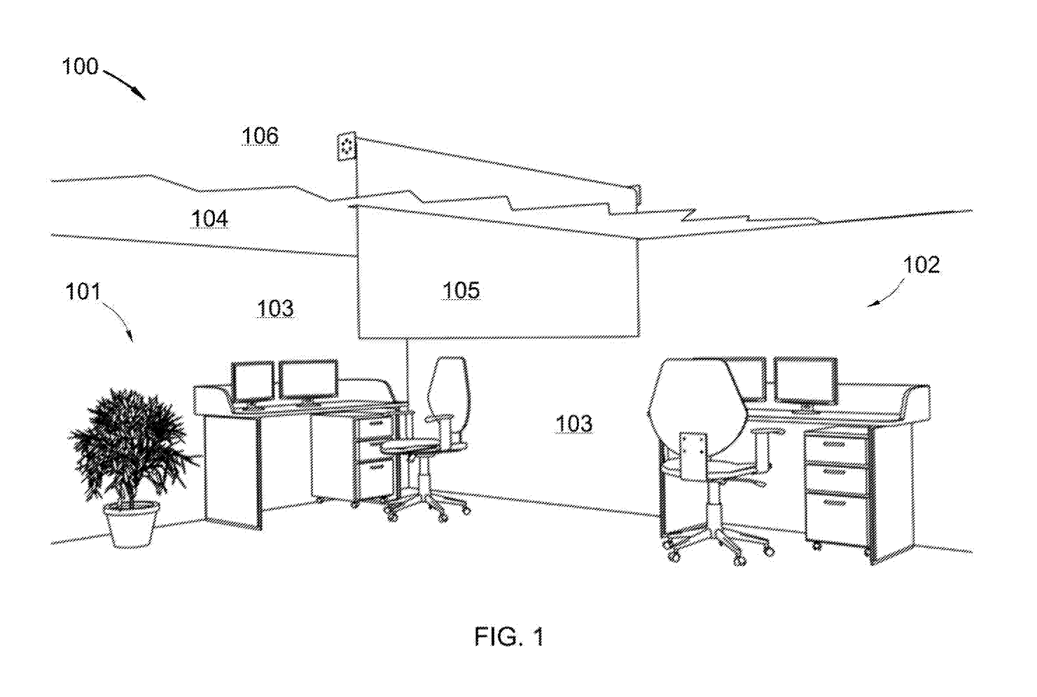

FIG. 1 depicts a modular office space. The office space 100 includes a first office area 101 and a second office area 102 enclosed by walls 103 and a ceiling 104. A spring-tensioned rollup wall 105 is disposed within a headspace 106 above the ceiling, and extends through a slot 107 in the ceiling. The roll-up wall may be rolled up to create a joint workspace, or may be deployed to create separate and/or private workspaces. This feature may be key to the modularity of the workspace. Although not depicted, the roll-up wall is mounted to surfaces in the headspace, as described herein.

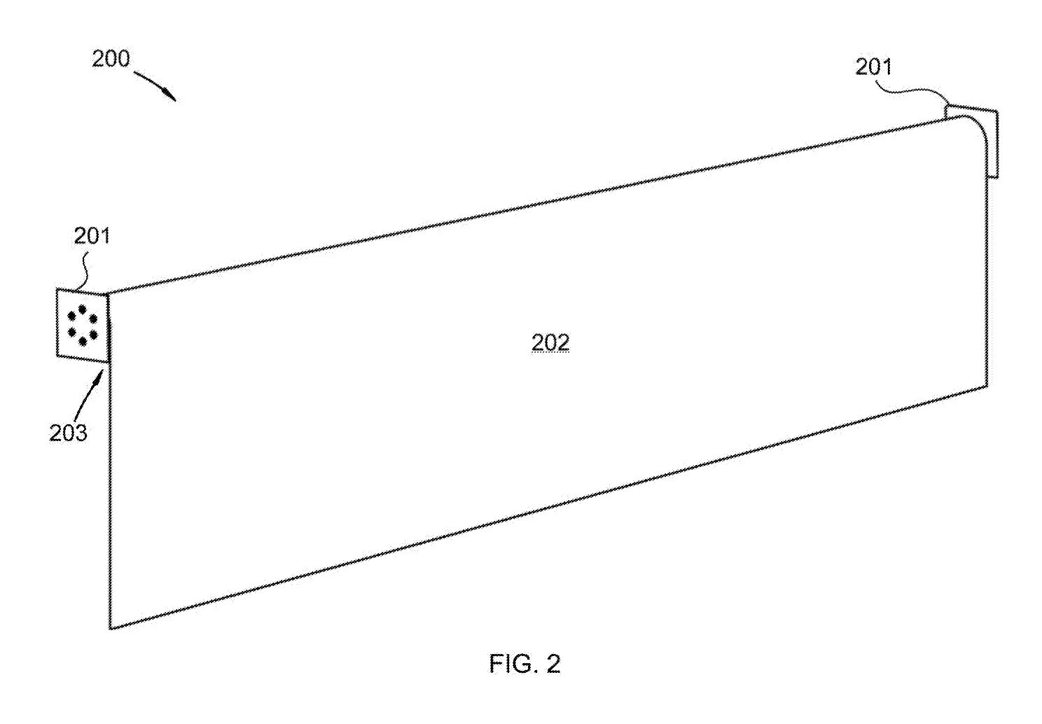

FIG. 2 depicts a roll-up wall assembly. The assembly 200 includes mounting brackets 201 and a flexible panel 202 wrapped around a roller tube 203. Further detail of various embodiments is shown in succeeding FIGs., including various optional internal components and an optional structure of the tube.

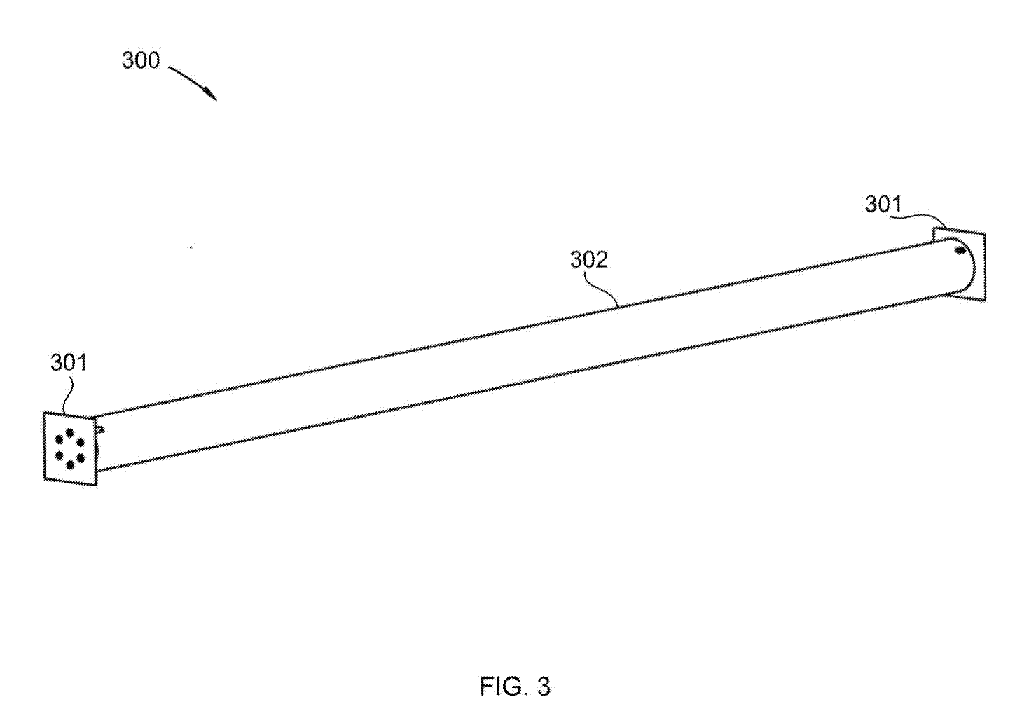

FIG. 3 depicts a roll-up wall assembly with the flexible panel removed. The assembly 300 includes mounting brackets 301 and a rigid tube 302.

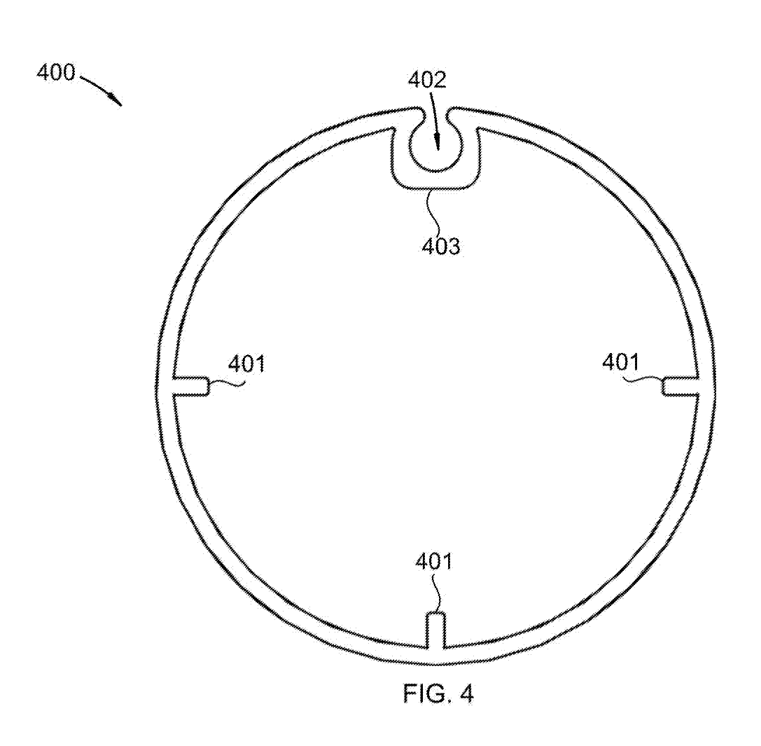

FIG. 4 depicts a cross-section of a roller tube. The tube 400 includes inward-protruding teeth 401, a panel groove 402, and a panel-groove tooth 403. A flexible panel 404 inserts into the panel groove and connects to the tube.

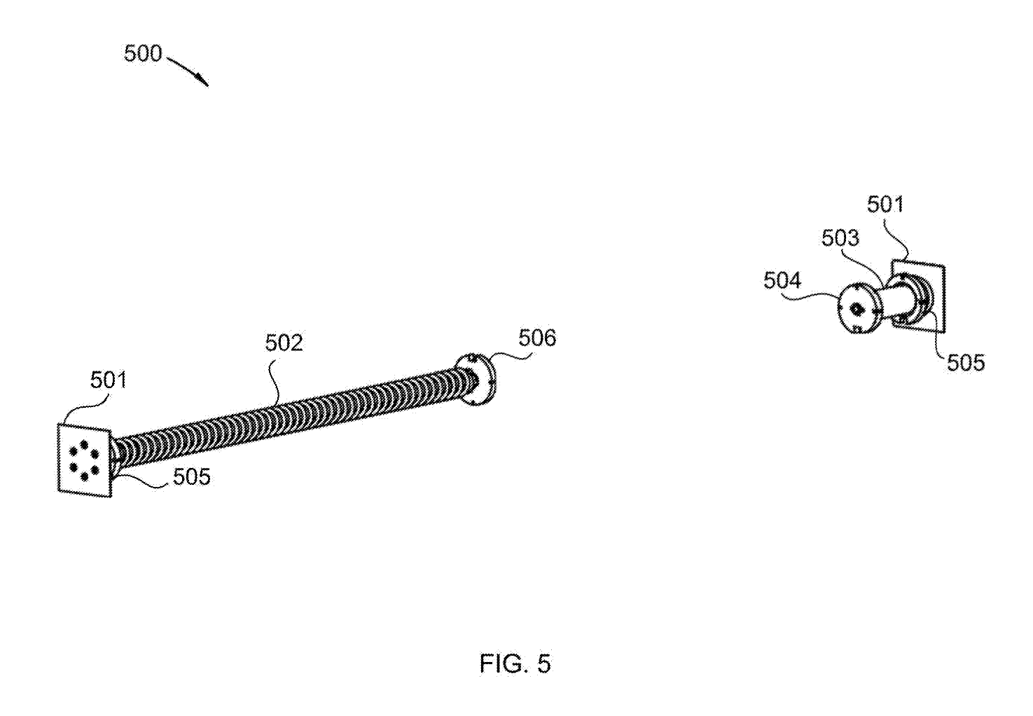

FIG. 5 depicts various internal components of a roll-up wall assembly. The assembly 500 includes mounting brackets 501, a torsion spring 502, a motor housing 503, a motor transmission 504, support rings 505, and a spring-tension transmission 506. The spring is fixed to the spring-tension transmission, which in turn fixes to a tube that surrounds the internal components. The spring is also fixed to the mounting bracket, which remains fixed with respect to the tube. The support rings rotate with the tube and support the tube on mounting bracket elements extending into the tube.

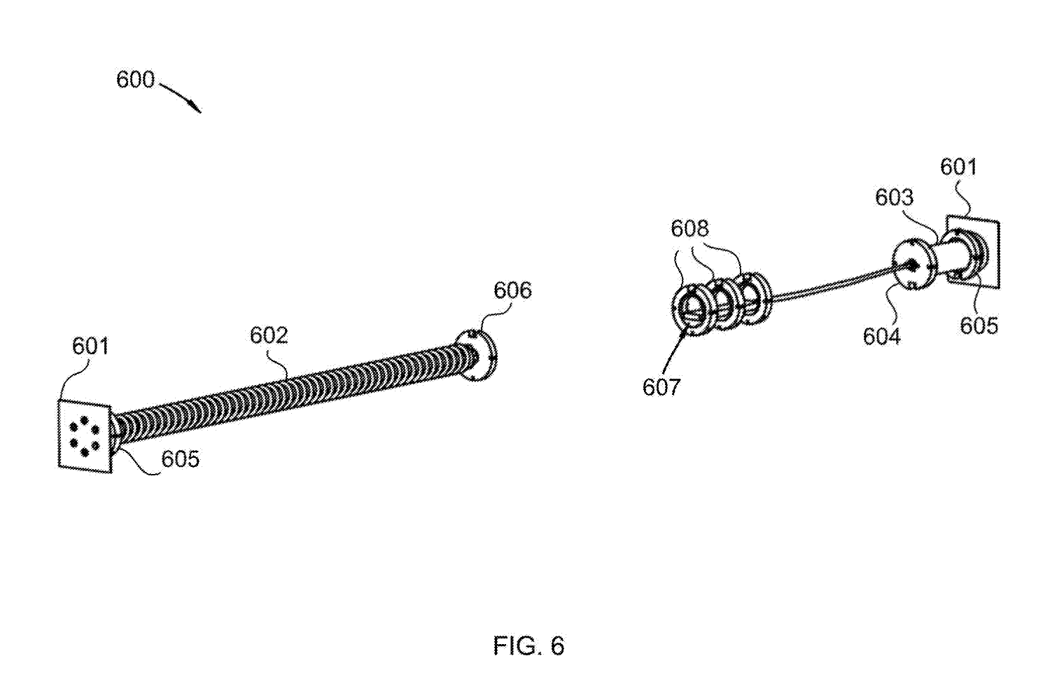

FIG. 6 depicts an additional embodiment of various internal components of a roll-up wall assembly. The assembly 600 includes mounting brackets 601, a torsion spring 602, a motor housing 603, a motor transmission 604, support rings 605, a spring-tension transmission 606, a battery 607, and a bottom-weighted support ring 608. The battery powers a motor disposed within the motor housing. The bottom-weighted support ring keeps the battery stationary as the tube rotates.

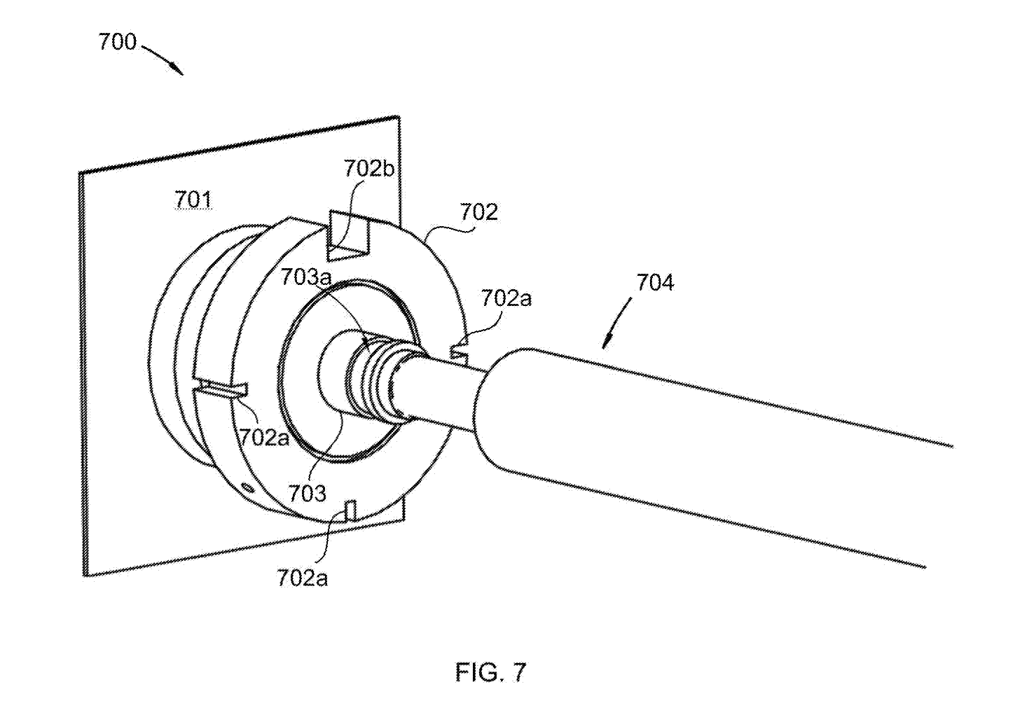

FIG. 7 depicts a zoomed-in view of internal components of a roll-up wall assembly. The assembly 700 includes a mounting bracket 701, a support ring 702, a mounting bracket support element 703 with groove 703a that correspond to set screws in the torsion spring, and a bar 704 that connects to the support element. The support ring is rotatably mounted to the support element and rotatably connects the tube to the mounting bracket. The support ring includes narrow grooves 702a and a wide groove 702b. The wide groove corresponds to a groove in the tube within which the flexible panel mounts.

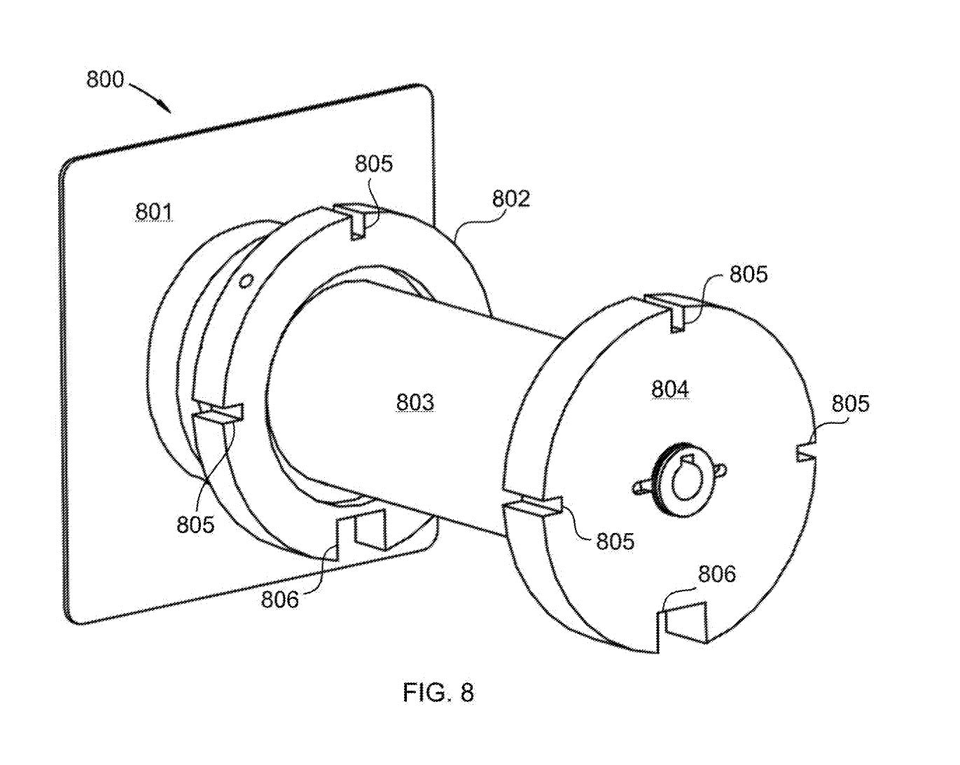

FIG. 8 depicts a zoomed-in view of various other internal components of a roll-up wall assembly. The assembly 800 includes a mounting bracket 801, a support ring 802, a motor housing 803, and a transmission 804. The support ring is rotatably connected to the motor housing. The motor housing is fixed to the support bracket. The transmission and support ring include narrow grooves 805 and wide grooves 806 that correspond to inward-protruding teeth of a tube that mounts around the depicted internal components.

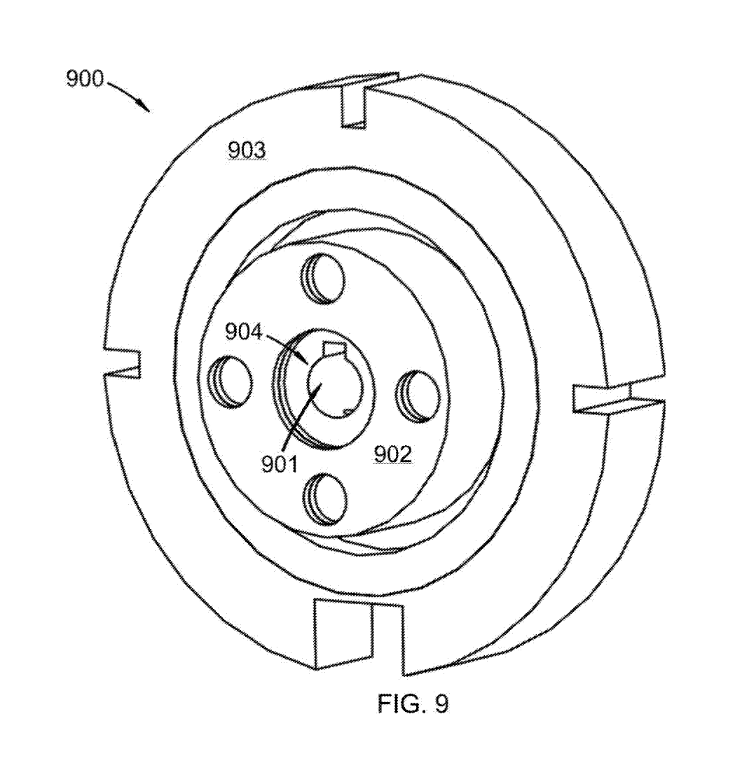

FIG. 9 depicts a motor transmission. The motor transmission 900 includes a rotor shaft 901, a cam brake housing 902, a slip ring 903, and a cam brake 904. The rotor of the motor passes through the rotor shaft and fixes to the brake. The cam brake rotates with the rotor and the transmission. The cam brake housing is connected to a motor housing, which is fixed to a mounting bracket. Torque on the transmission independent of the rotor forces the cam against the cam brake housing and prevents rotation of the transmission.

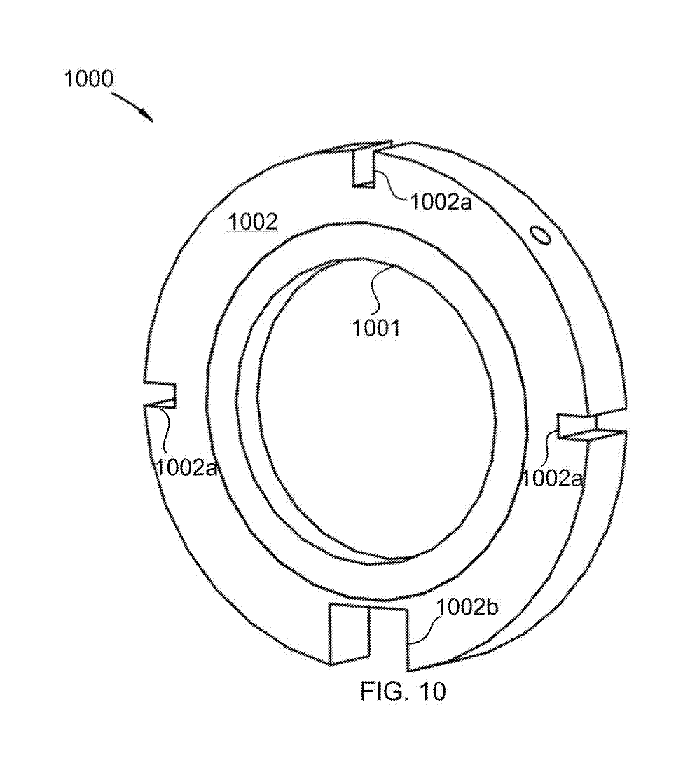

FIG. 10 depicts a slip ring. The slip ring 1000 includes a bearing ring 1001 and a grooved ring 1002. The grooved ring includes narrow grooves 1002a and a wide groove 1002b. The bearing ring fits onto a fixed portion of the roll-up wall assembly, such as a mounting bracket support element or a motor housing. The grooved ring fixes to the tube by teeth that extend into the grooves. The grooved ring rotates with respect to the bearing ring.

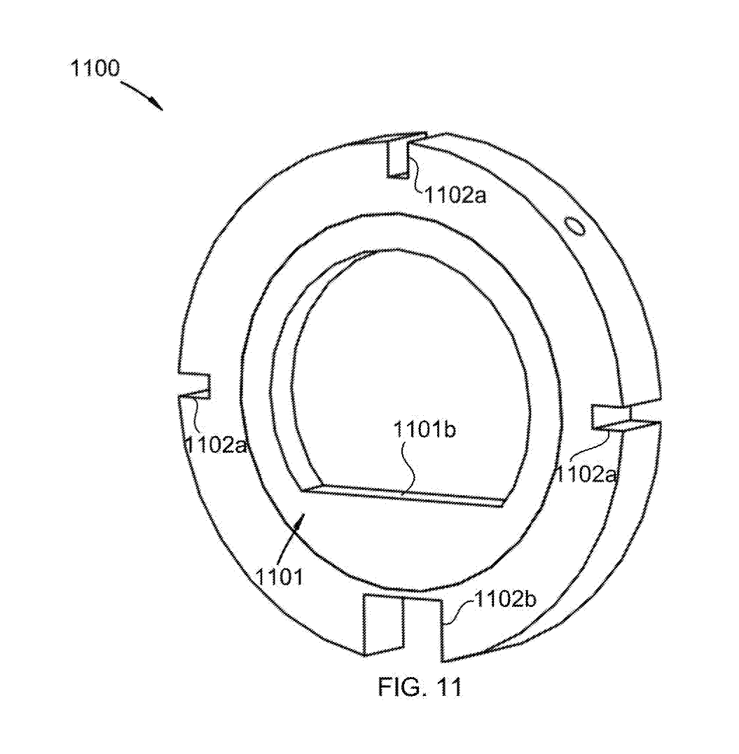

FIG. 11 depicts a bottom-weighted support ring. The bottom-weighted support ring 1100 includes a battery support segment 1101 and a grooved segment 1102 with narrow grooves 1102a and a wide groove 1102b. The battery support segment includes a weighted segment 1101a and a flat surface 1101b. A battery rests on the flat surface within the support ring.

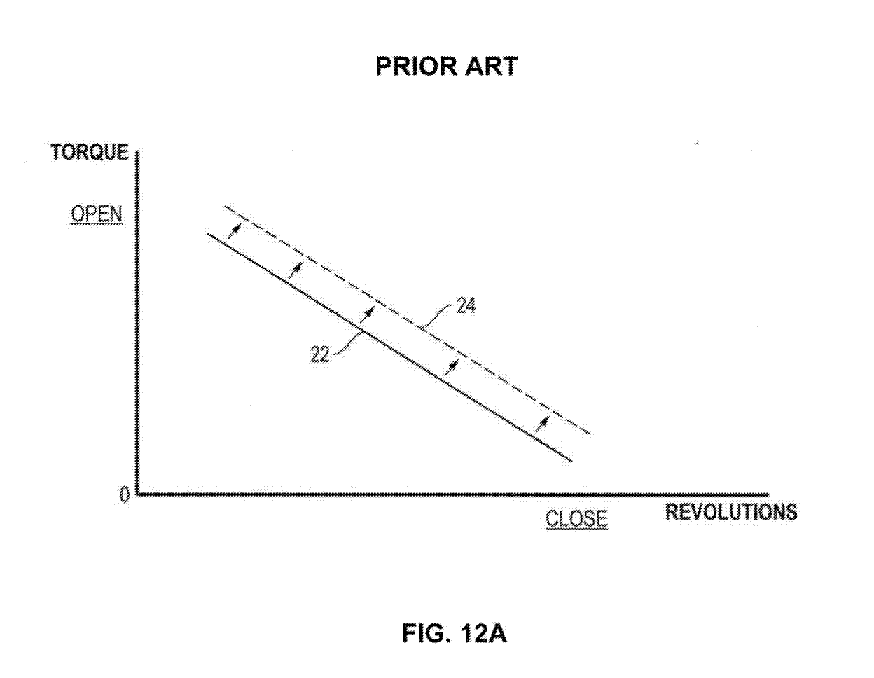

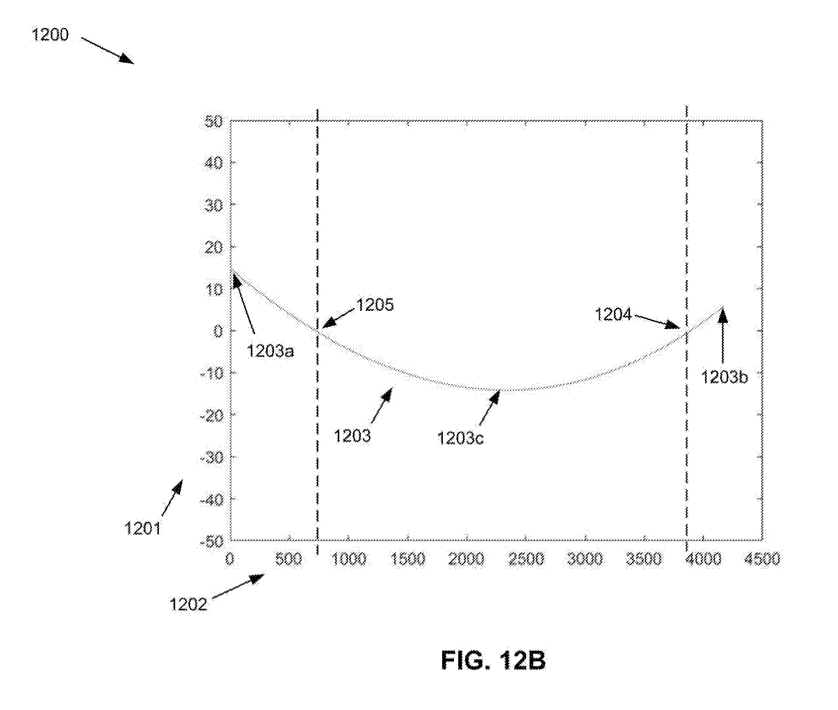

FIGS. 12A-B depict various torque profiles. FIG. 12A depicts a prior art torque profile, such as corresponds to the system described in U.S. Pub. No. 2015/0308186 by Mullet et al, published 29 Oct. 2015. FIG. 12A is a graph showing a torque profile 22 for a shade system. All the elements of the shade system that contribute to the weight of the shade that must be raised and lowered contribute to the shade system torque profile that is unique for each shade system. The shade system torque profile is linear with a negative gradient profile. The highest torque requirements are imposed when the shade is extended and reduce as revolutions increase and the shade is raised. Also illustrated is a counterbalance torque profile 24 in dotted lines. The counterbalance torque profile, in this example, has been created with a higher nominal torque than the shade system torque profile.

FIG. 12B depicts a trough-shaped torque profile of an apparatus as described herein. The torque profile 1200 is depicted as net torque 1201 in in-lb as a function of hundredths of radians 1202, where zero radians represents the panel fully unrolled. A torque curve 1203 is trough-shaped, with global maximum 1203a and local maximum 1203b on either side of global minimum 1203c. The global maximum is approximately 15 in-lb, and the global minimum is approximately −15 in-lb. At intersections 1204 and 1205, the net torque is zero. The trough-shape is a result of the pre-torsioning, the linear change of T_{spring}, the exponential change of T_{wall}, and a constant Tₘₒₜₒᵣ. However, the torque profile can be flattened such that Tₙₑₜ is approximately constant and close to zero by varying Tₘₒₜₒᵣ as described previously.

We claim:

1. A spring-tensioned roll-up apparatus, comprising:
a flexible panel comprising a bottom end and a top end;
a roller tube connected to the top end, wherein the panel rolls onto, and off of, the tube;
one or more mounting brackets, at least one mounting bracket rotatably connected to the tube;
a braking mechanism connected to the tube and at least one of the one or more mounting brackets, wherein the braking mechanism prevents rotation of the tube relative to the one or more mounting brackets; and
a torsion spring disposed within the tube and comprising a first end connected directly, indirectly, or both, to the tube and a second end connected directly, indirectly, or both to at least one of the mounting brackets,
wherein the spring is pre-torsioned before the mounting brackets are mounted to a mounting surface by rotating the second end of the spring relative to the first end of the spring in the same direction as the tube rotates to roll the panel off the tube such that the apparatus comprises a trough-shaped torque profile.

2. The spring-tensioned roll-up apparatus of claim 1, wherein the spring traverses its equilibrium torsional state as the panel is unrolled from the tube from one percent to 30 percent of the panel's length.

3. The spring-tensioned roll-up apparatus of claim 1, wherein the spring is pre-torsioned as the panel is rolled fully onto the tube.

4. The spring-tensioned roll-up apparatus of claim 1, further comprising a motor and transmission assembly that rotates the tube and rolls the panel onto, and off of, the tube, the motor and transmission assembly disposed within the tube, wherein the motor comprises a variable torque that flattens the apparatus torque profile.

5. The spring-tensioned roll-up apparatus of claim 4, wherein the motor and transmission assembly comprises a stator connected to at least one of the one or more mounting brackets, a transmission directly fixed to the tube, and a rotor rotatably connecting the stator and the transmission

6. The spring-tensioned roll-up apparatus of claim 5, further comprising a housing disposed within the tube and at least partially enclosing one or more of the stator and the rotor, the housing directly fixed to the at least one mounting bracket, the stator directly fixed to the housing, the rotor rotatably connected directly to the housing, and the transmission disposed around an end of the housing opposite the mounting bracket.

7. The spring-tensioned roll-up apparatus of claim 6, further comprising a support ring rotatably connected directly to the housing and directly fixed to the tube.

8. The spring-tensioned roll-up apparatus of claim 4, further comprising a battery disposed within the tube between the spring and the motor, the battery electrically coupled to the motor.

9. The spring-tensioned roll-up apparatus of claim 8, wherein the battery is rotatably connected to the tube by a support bearing such that the tube rotates freely around the battery

10. The spring-tensioned roll-up apparatus of claim 1, wherein the flexible panel comprises mass-loaded vinyl.

11. The spring-tensioned roll-up apparatus of claim 1, wherein the tube comprises a number of inward-protruding teeth.

12. The spring-tensioned roll-up apparatus of claim 11, wherein one or more of the teeth span the entire length of the tube.

13. The spring-tensioned roll-up apparatus of claim 11, wherein the teeth are evenly spaced or unevenly spaced.

14. The spring-tensioned roll-up apparatus of claim 1, further comprising a bar disposed within the spring and connected at one end to at least one of the one or more mounting brackets and at the other end to the tube, the spring directly connected to the bar.

15. The spring-tensioned roll-up apparatus of claim 14, wherein the spring is extended from the spring's free-standing equilibrium length as it is connected to the bar.

16. The spring-tensioned roll-up apparatus of claim 14, further comprising a first spring-tension transmission directly fixed to the bar and directly fixed to the tube.

17. The spring-tensioned roll-up apparatus of claim 14, further comprising a second spring-tension transmission rotatably connected to the bar and directly fixed to the tube.

18. The spring-tensioned roll-up apparatus of claim 1, wherein the tube comprises a groove, wherein the top end of the flexible panel inserts into the groove and directly connects the flexible panel to the tube.

19. The spring-tensioned roll-up apparatus of claim 18, wherein the groove forms an inward-protruding tooth in the tube.

20. The spring-tensioned roll-up apparatus of claim 1, wherein a controller receives inputs from a sensor and includes instructions for detecting and preventing the motor from over tensioning the spring.
